(19) United States
(12) Patent Application Publication
(10) Pub. No.: US 2012/0207086 A1
(43) Pub. Date: Aug. 16, 2012

(54) SIMULTANEOUSLY SUPPORTING MULIPLE 3GPP STANDARD VERSIONS

(75) Inventors: Mike Vihtari, Kanata (CA); Matthew Yee, Ottawa (CA); Kugendran Sabaratnam, Kanata (CA)

(73) Assignee: ALCATEL-LUCENT CANADA, INC., Ottawa (CA)

(21) Appl. No.: 13/024,958

(22) Filed: Feb. 10, 2011

(51) Int. Cl. H04W 76/00

(52) U.S. Cl. 370/328

(57) ABSTRACT

Embodiments are disclosed that enable a device such as a policy and charging rules function (PCRF) node to operate with other nodes in a long term evolution (LTE) network that are operating at different respective major-minor release combinations of the 3^{rd} Generation Partnership Project (3GPP) standards. Some embodiments enable such a device to operate with another node at a given major-minor release combination of the 3GPP standards with respect to an existing session being managed by the device and at another major-minor release combination of the 3GPP standards when a new session is established by the device. Advantageously, such embodiments mitigate the risk of adversely affecting the existing session after a minor release upgrade of the node associated with the session is performed.

### CROSS REFERENCE TO RELATED APPLICATIONS

This United States non-provisional patent application does not claim priority to any United States provisional patent application or any foreign patent application.

### FIELD OF THE DISCLOSURE

The disclosures made herein relate generally to the telecommunications industry. The invention discussed herein is in the general classification of a device capable of operation in a mode compatible with different versions of the 3GPP standards and a method for operating according to different versions of the 3GPP standards at the PCRF node.

### BACKGROUND

This section introduces aspects that may be helpful in facilitating a better understanding of the invention. Accordingly, the statements of this section are to be read in this light and are not to be understood as admissions about what is in the prior art or what is not in the prior art.

Several technical terms and/or phrases will be used throughout this application and merit a brief explanation.

The 3^{rd} Generation Partnership Project (3GPP) attempts to create a uniform third-generation mobile phone system. 3GPP standards are called releases and different functionality is present in the different versions of the releases.

The 3GPP standards continue to evolve and the major releases of the standards can be differentiated using supported features. However, there also may be differences between minor versions of the 3GPP standards that render them incompatible with each other. It is required that a single release of the Policy and Charging Rules Function (PCRF) be used with different networks operating with different minor versions of the standards.

A base transceiver station (BTS or BS) is used between a mobile phone and a network to permit wireless communication. It can be a radio base station (RBS), node B for 3G networks or enhanced node B for long term evolution (LIE) networks.

A global system for mobile communications (GSM) network includes a network and switching subsystem (NSS) with a mobile switching center (MSC) and associated registers (e.g. home location register (HLR) and visitor location register (VLR)), a base station controller (BSC) and multiple BTSs and an operations support system (OSS).

The GSM originally only involved a circuit switched network for voice calls and short messaging services (SMS). However, it was extended to include packet-switched data services via the General Packet Radio Service (GPRS) core network to permit Internet access.

A MSC is the service delivery node for GSM in charge of routing voice calls. The gateway MSC (GMSC) is an MSC that ascertains the location of a subscriber who is being called by checking the HLR. The gateway MSC also interfaces with the Public Switched Telephone Network (PSTN).

The HLR is a central database containing mobile phone subscriber information. A VLR is a temporary database containing information related to mobile phone subscribers that are roaming in an area the VLR serves. Each BTS is served by a VLR.

A gateway GPRS Support Node (GGSN) permits interaction between the GPRS network which is used for transmitting Internet Protocol (IP) packets and external packet switched networks. When a GGSN receives data addressed to a user, it is forwarded to the serving GPRS support node (SGSN) for delivery to the mobile stations in its service area.

System architecture evolution (SAE) is the architecture of 3GPP's LIE wireless communication standard. The evolved packet core (EPC) is the equivalent of GPRS networks and includes a mobile management entity (MME), a serving gateway (SGW), a Public Data Network (PDN) gateway (PGW or PDN GW), and a policy and charging rules function (PCRF) node.

The MME is the control node for the LTE network. It tracks mobile devices and selects the SGW for a mobile device. The SGW sends data packets while the PGW permits the mobile phone to connect to external data networks. The PCRF node is a concatenation of Policy Decision Function (PDF) and Charging Rules Function (CRF).

Currently, all components in a network implement the same or compatible minor versions of the 3GPP standards. New product releases are required to implement the supported 3GPP standards version of the network. However, it is not always possible during trials of product releases (i.e. live deployments) to change product releases. It is also a maintenance issue to have multiple versions of a product for the multiple minor versions of the 3GPP standards. There is no means to distinguish between minor versions of the 3GPP standards and/or determine which minor version is being used in a network component.

Hence, there is a need for a device that efficiently, reliably and affordably permits operation in a mode compatible with different versions of the 3GPP standards and a methodology that permits determination and selection of different versions of the 3GPP standards at the PCRF node. Furthermore, in the case where a network component has been upgraded from one minor release to another while a subscriber session is existing, i.e. established and possibly providing a service to the subscriber, it would be desirable to mitigate the risk of adversely affecting that session.

### SUMMARY OF THE DISCLOSURE

Some embodiments of the invention enable a device such as a PCRF node to operate with other nodes in an LTE network that are operating at different respective major and minor (hereinafter major-minor) release combinations of the 3GPP standards.

Some embodiments of the invention enable a device such as a PCRF node to operate with another node in an LTE network at a given major-minor release combination of the 3GPP standards with respect to an existing session being managed by the device and at another major-minor release combination of the 3GPP standards when a new session is established by the device.

According to an aspect of the invention a device for controlling sessions in a network is provided. The device includes an interface for communicating with an entity operable to send and receive messages regarding a session; data storage adapted to store session data related to the session and to store configuration data corresponding to the entity; and a controller operable to determine, from the configuration data, a major-minor release combination of the entity responsive to receiving, from the entity, a message requesting establishment of a new session, and to determine, from the session data, a major-minor release combination of an existing session responsive to receiving, from the entity, a message regarding the existing session.

Advantageously, by enabling an existing session to be managed at one major-minor release combination of the 3GPP standards and a new session to be subsequently created under another major-minor release combination of the 3GPP standards, some embodiments of the invention mitigate the risk of adversely affecting the existing session after a minor release upgrade of a node that is associated with the session is performed.

In some embodiments the data storage is further adapted to store network configuration data, and the controller is further operable to determine, in the absence of configuration data corresponding to the entity, a major-minor release combination from the configuration data responsive to receiving the message requesting establishment of the new session.

In some embodiments the data storage is further adapted to store information corresponding to functions supported by the device for a given major-minor release combination, and the controller is operable to validate, in dependence upon said information, the message regarding the existing session.

According to another aspect of the invention a method of controlling sessions performed by a device is provided. The method comprises the steps of receiving a session request from a node; determining if there is an established session corresponding to the request; determining, responsive to there not being an established session, a major-minor release combination at which the node is operating and establishing a new session associated with the major-minor release combination; and determining, responsive to there being an established session, a major-minor release combination associated with the established session.

In some embodiments of the method if it is determined that there is an established session, the method includes determining if the request is valid; and executing an invalid message procedure responsive to the request not being valid, or processing the request responsive to the request being valid.

In some embodiments of the method determining the major-minor release combination at which the node is operating includes determining if there is an entry for the node in a storage of configuration data; retrieving, responsive to there not being said entry, a default network-wide major-minor release combination identifier from said storage; and retrieving, responsive to there being said entry, an identifier indicating the major-minor release combination at which the node is operating from said storage.

Some embodiments of the methodology may involve supporting multiple minor versions of the 3GPP standards at the PCRF node; determining which minor version of the 3GPP standards is used by a component in a network; selecting the minor version of the 3GPP standards supported by the component in the network; and utilizing the minor version of the 3GPP standards supported by the component in the network for sending content and messaging from the PCRF node.

Some embodiments of the device (e.g. PCRF node) include a memory containing instructions processed by a processor. The instructions may include instructions for operating internally at the PCRF node at a highest supported minor version of the 3GPP standards; sending internal messaging and processing data at the PCRF node according to the highest supported minor version of the 3GPP standards; supporting multiple minor versions of the 3GPP standards at the PCRF node; determining which minor version of the 3GPP standards is used by a component in a network; selecting the minor version of the 3GPP standards supported by the component in the network; and utilizing the minor version of the 3GPP standards supported by the component in the network for sending content and messaging from the PCRF node.

Under some applications, embodiments may provide a reliable device and method that permit selection of different minor versions of the 3GPP standards for operation at the PCRF node.

### BRIEF DESCRIPTION OF THE DRAWINGS

Some embodiments of apparatus and/or methods of the present invention are now described, by way of example only, and with reference to the accompanying drawings, in which:

FIG. 1 depicts a 2G/3G mobile generation network and a LTE network.

FIG. 2 depicts a LTE network and the components of the EPC.

FIG. 3 depicts the SGW of a LTE network handling a mobile device moving from a location serviced by a first eNodeB to a location serviced by a second eNodeB.

FIG. 4 depicts one or more service data flows (SDFs) aggregated and carried over bearers.

FIG. 5 depicts three segments that constitute an end-to-end bearer.

FIG. 6 depicts how the PCRF node interfaces with other EPC elements.

FIG. 7 depicts the dynamic nature of policy and mobility management in a LTE network.

FIG. 8 depicts a method of internal operation at the PCRF node according to a first embodiment of the invention.

FIG. 9 depicts a method of operation of the interface components of the PCRF node according to a second embodiment of the invention.

FIG. 10 depicts a device capable of operating according to different minor versions of the 3GPP standards in accordance with a third embodiment of the invention.

FIG. 11 depicts an alternative implementation of the device of FIG. 10 in accordance with a fourth embodiment of the invention.

FIG. 12 depicts operation of the PCRF node and messaging between the PCRF node and an EPC node in a release upgrade scenario and in accordance with a fifth embodiment of the invention.

FIG. 13 depicts a method of managing sessions performed at the PCRF node in accordance with a sixth embodiment of the invention.

FIG. 14 depicts a step in the method of FIG. 13 in greater detail.

### DETAILED DESCRIPTION OF THE DRAWINGS

The evolved packet core (EPC) is an all-IP mobile core for the long term evolved (LTE) network that involves a converged framework for packet-based real-time and non-real-time services. The EPC is specified by 3GPP Release 8 that was finalized in the first quarter of 2009.

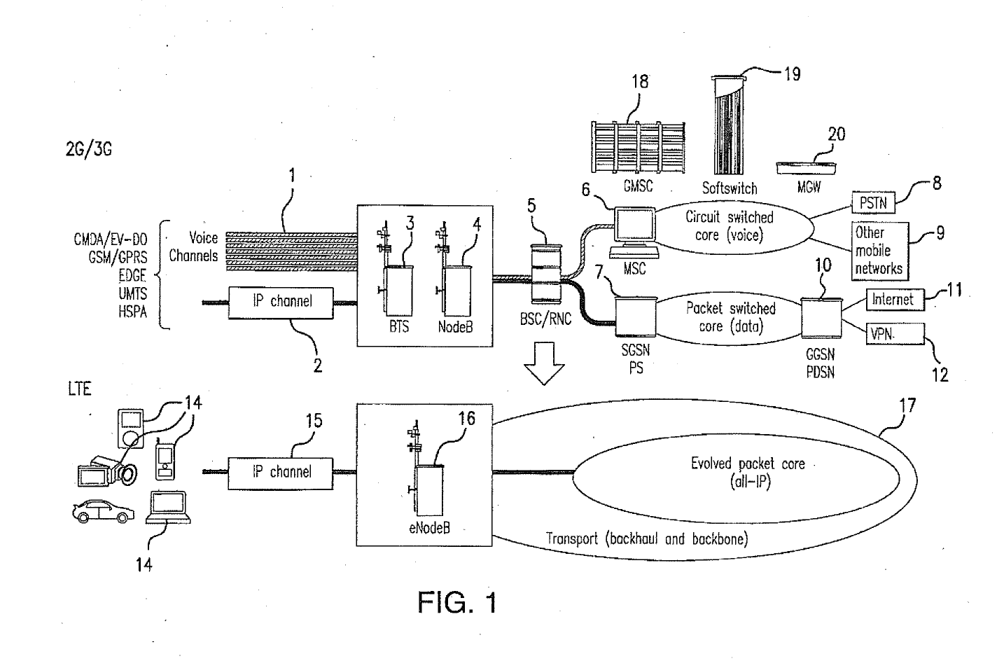

The EPC provides mobile core functionality that in previous mobile generations (e.g. 2G and 3G) has been realized through two separate sub-domains: circuit-switched (CS) for voice and packet-switched (PS) for data. As shown in FIG. 1, in previous mobile generations (e.g. 2G and 3G), both voice channels 1 and IP channels 2 are utilized to connect with a BTS 3 or NodeB 4. This permits transmission to a BSC or RNC 5 connected to a MSC 6 or SGSN 7. The RNC 5 controls the NodeBs that are connected to it and connects to the circuit switched core network through a media gateway (MGW) 20 and MSC 6 and to the SGSN 7 in the packet switched core network. The MSC 6 permits circuit switched traffic to travel to the PSTN S or other mobile networks 9. The SGSN 7 permits packet switched traffic to travel to a GGSN 10 and onto the Internet 11 or a Virtual Private Network (VPN) 12. The VPN 12 is an overlay network that permits private data to be sent securely over the Internet. A GMSC 18 responsible for determining which MSC a call recipient is visiting and a softswitch 19 responsible for connecting telephone calls from one phone line to another are also depicted in FIG. 1.

As shown in FIG. 1, in a LTE network, these two distinct mobile core sub-domains used for separate processing and switching of mobile voice and data are unified as a single IP domain (IP channel 15). LTE is an end-to-end all-IP network from mobile handsets and other terminal devices 14 with embedded IP capabilities over IP-based Evolved NodeBs (eNodeBs) 16 (i.e. LTE base stations) and across the EPC 17 and throughout the application domain (both IP Multimedia Subsystem (IMS) and non-IMS).

EPC 17 is essential for end-to-end IP service delivery across the LTE network. The EPC 17 is also instrumental in allowing the introduction of new business models, such as partnering/revenue sharing with third-party content and application providers. EPC 17 promotes the introduction of new innovative services and the enablement of new applications.

EPC 17 addresses LTE requirements to provide advanced real-time and media-rich services with enhanced Quality of Experience (QoE). EPC 17 improves network performance by the separation of control and data planes and through a flattened IP architecture that reduces the hierarchy between mobile data elements (e.g. data connections from eNodeB 16 only traverse through EPC gateways).

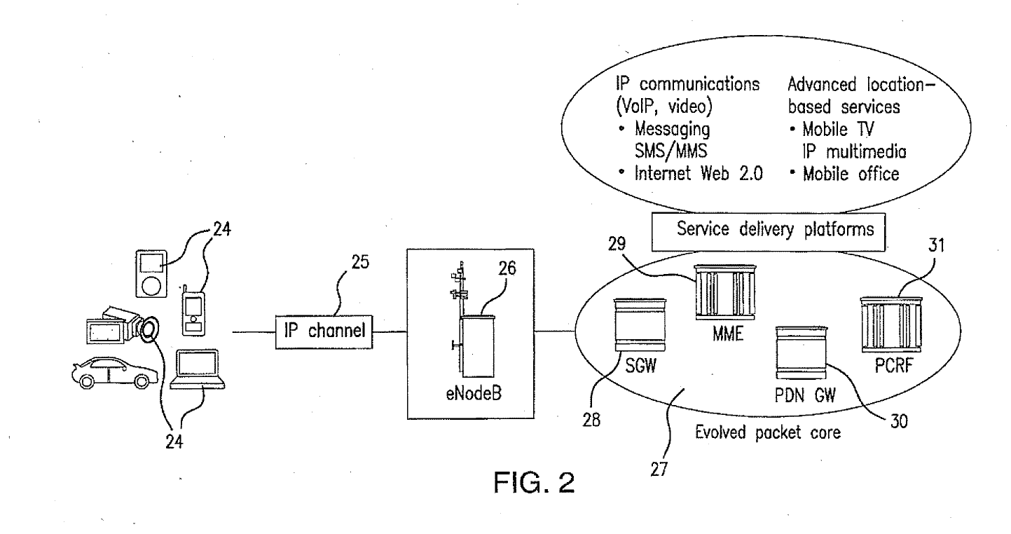

FIG. 2 depicts a LTE network with the components of the EPC. FIG. 2 shows the EPC 27 as a core part of the all-IP environment of the LTE network. In the LTE network, the two distinct mobile core sub-domains used for separate processing and switching of mobile voice and data in 2G/3G networks are unified as a single IP domain (IP channel 25). The LTE network is an end-to-end all-IP network from mobile handsets and other terminal devices 24 with embedded IP capabilities over IP-based Evolved NodeBs 26 and across the EPC 27.

The introduction of the EPC 27 and all-IP network architecture in the mobile network has profound implications on mobile services, as all voice, data and video communications are built on the IP protocol. EPC 27 also permits interworking of the new mobile architecture with previous mobile generations (e.g. 2G or 3G) and the scalability required by each of the core elements to address dynamic terminal mobility and dramatic increases in bandwidth and the number of direct connections to user terminals. The EPC 27 also increases the reliability and availability delivered by each element to insure service continuity.

To address a radically different set of network and service requirements, the EPC 27 must represent a departure from existing mobile networking paradigms. Introduction of EPC 27 with the LTE network in many ways represents a radical departure from previous mobile paradigms. It signals the end of circuit-switched voice. The LTE network uses a new paradigm for voice traffic called Voice-over-1P (VoIP). This ends a period of more than twenty (20) years during which one application dictated the whole network architecture. EPC 27 treats voice as just one of many IP-based network applications, albeit an important one that requires superb packet network performance and one that is responsible for significant operator revenues.

The LTE network must match and exceed the QoE of wireline broadband. This is quite different from providing best-effort and low-speed web browsing or Short Message Service (SMS) which are two data applications for which the existing PS mobile cores are optimized.

In the LTE network, all mobility management is moved into the mobile core and becomes the responsibility of the MME 29. This is a consequence of the split of functions previously performed by the RNC/BSC and NodeB/BTS. The MME 29 requires a control plane capacity that is an order of magnitude larger than the SGSN or PDSN and must insure interworking with 2G/3G legacy mobile systems.

The LTE network must provide superior end-to-end Quality-of-Service (QoS) management and enforcement in order to deliver new media-rich, low-latency and real-time services. There is an expected move from four classes of service (CoS) available in 3G to nine QoS profiles with strict performance targets. This must be achieved while ensuring scalability of users, services and data sessions. In addition, although not a part of the 3GPP Release 8 specification set, deep packet inspection (DPI) and other advanced packet processing are required.

In a LTE network, service control is provided via the Policy and Charging Rules Function (PCRF) 31. This is a change from previous mobile systems, where service control was realized primarily through user equipment (UE) authentication by the network. The PCRF 31 dynamically controls and manages all data sessions and provides appropriate interfaces toward charging and billing systems as well as enables new business models.

The LTE network requires significantly more capacity in both the data plane and control plane. The existing 2G/3G mobile core elements cannot fully address LTE requirements without a series of upgrades to the platforms. Most of the existing platforms are ill-suited for high-capacity packet processing. Scaling the packet processing requirements on these platforms results in higher consumption of system capacity, high latency, low performance and dramatic performance/feature tradeoffs. In some cases, performance drops more than fifty percent (50%) when features like charging are enabled. Legacy core platforms must dramatically change their product architectures to handle LTE, and even with these architectural changes, they are only a stop-gap solution that may require complex upgrade scenarios to address LTE scalability and performance requirements.

While LTE introduces a clear delineation of the data (user) plane and a control plane, it also imposes two sets of distinct technical requirements on the data plane and control plane. The data plane needs to address requirements for high bandwidth, high availability and scalability with aggregate throughput (per gateway) easily reaching over 100 Gb/s (100 gigabits per second). At the same time, the data plane needs to allow unaffected wirespeed performance with sophisticated processing of millions of service data flows and data bearers turned on while being able to provide sophisticated, fine-granular (per-application, per-service, per-user) QoS. The control plane needs to address the requirements for high scalability and high availability of secure mobility and connection management along with highly reliable and scalable network-wide policy and subscriber management.

The EPC is realized through four new elements: Serving Gateway (SGW) 28; Packet Data Network (PDN) Gateway (PGW or PDN GW) 30; Mobility Management Entity (MME) 29; and Policy and Charging Rules Function (PCRF) 31.

While SGW 28, PDN GW 30 and MME 29 were introduced in 3GPP Release 8, PCRF 31 was introduced in 3GPP Release 7. Until recently, the architectures using PCRF 31 have not been widely adopted. The PCRF's interoperation with the EPC gateways and the MME 29 is mandatory in Release 8 and essential for the operation of the LTE.

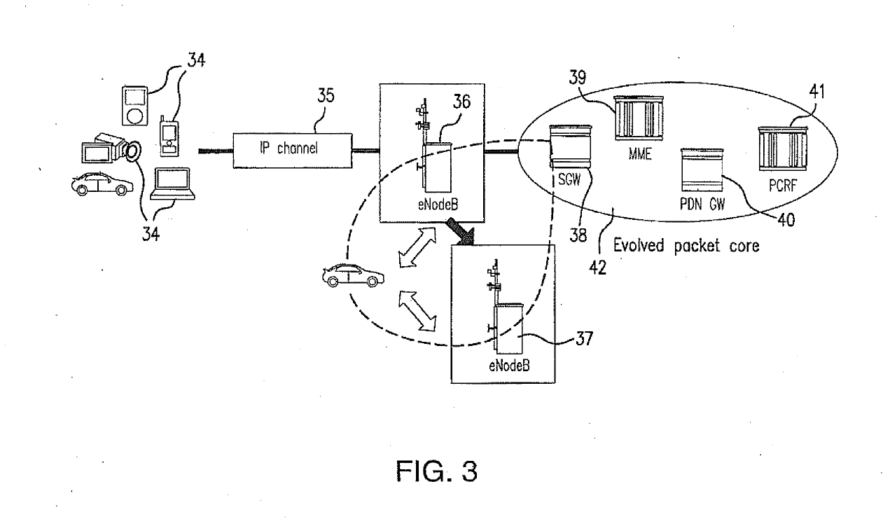

FIG. 3 depicts the SGW of a LTE network handling a mobile device moving from a location serviced by a first eNodeB to a location serviced by a second eNodeB. In the LTE network, the two distinct mobile core sub-domains used for separate processing and switching of mobile voice and data in 2G/3G networks are unified as a single IP domain (IP channel 35). LTE is an end-to-end all-IP network from mobile handsets and other terminal devices 34 with embedded IP capabilities over IP-based Evolved NodeBs 36 and 37 and across the EPC 42. The EPC 42 has a SGW 38, a MME 39, a PDN GW 40 and a PCRF 41.

The SGW 38 is a data plane element whose primary function is to manage user-plane mobility and act as a demarcation point between the RAN and core networks. SGW 38 maintains data paths between eNodeBs 36 and 37 and the PDN GW 40. From a functional perspective, the SGW 38 is the termination point of the packet data network interface toward evolved universal terrestrial radio access network (E-UTRAN). When terminals move across areas served by eNodeB elements 36 and 37 in E-UTRAN, the SGW 38 serves as a local mobility anchor. This means that packets are routed through this point for intra E-UTRAN mobility and mobility with other 3GPP technologies such as 2G/GSM and 3G/UMTS.

Like the SGW 38, the Packet Data Network Gateway (PDN GW) 40 is the termination point of the packet data interface toward the packet data network(s). As an anchor point for sessions toward the external packet data networks, the PDN GW 40 supports: policy enforcement features (e.g. applies operator-defined rules for resource allocation and usage); packet filtering (e.g. deep packet inspection for application type detection); and charging (e.g. per-URL charging).

In LTE, data plane traffic is carried over virtual connections called service data flows (SDFs). SDFs, in turn, are carried over bearers (i.e. virtual containers with unique QoS characteristics).

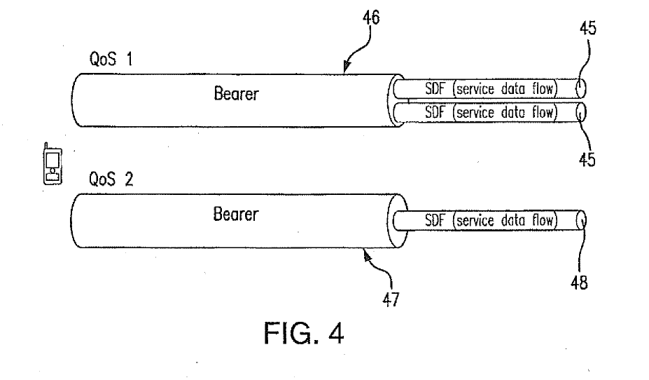

FIG. 4 depicts one or more SDFs aggregated and carried over bearers. Two SDFs 45 are located in bearer 46 and one SDF 48 is located in bearer 47.

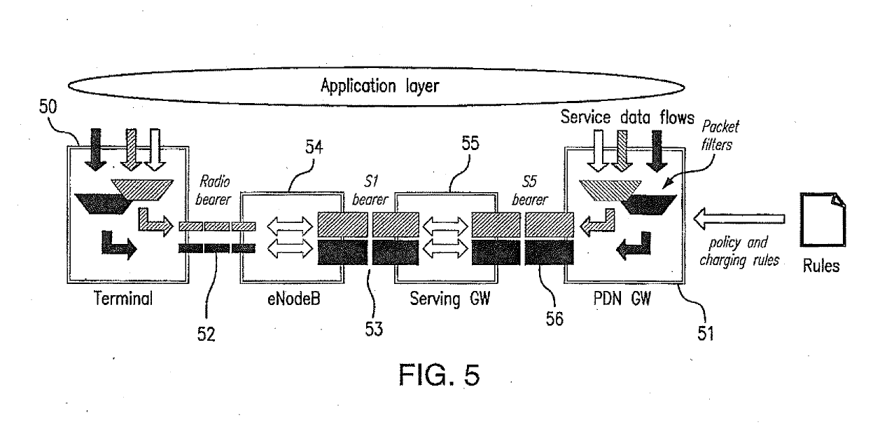

FIG. 5 depicts three segments that constitute an end-to-end bearer. One bearer, a datapath between a UE (terminal) 50 and a PDN GW 51, has three segments: radio bearer 52 between UE (terminal) 50 and eNodeB 54; data bearer 53 between eNodeB 54 and SGW 55 (S1 bearer 53); and data bearer 56 between SGW 55 and PDN GW 51 (S5 bearer 56).

The primary role of the PDN GW 51 is QoS enforcement for each of these SDFs, while SGW 55 focuses on dynamic management of bearers.

As shown in FIG. 3, the Mobility Management Entity (MME) 39 is a nodal element within the EPC 42. MME 39 performs the signaling and control functions to manage the User Equipment (UE)/terminal devices 34 and their access to network connections. The MME 39 also manages the assignment of network resources and the mobility states to support tracking, paging, roaming and handovers. MME 39 controls all control plane functions related to subscriber and session management.

MME 39 manages thousands of eNodeB elements, which is one of the key differences from requirements previously seen in 2G/3G (on RNC/SGSN platforms). The MME 39 is the key element for gateway selection within the EPC 42 (i.e. selection of SGW and PDN GW). The MME 39 also performs signaling and selection of legacy gateways for handovers for other 2G/3G networks. The MME 39 also performs the bearer management control functions to establish the bearer paths that the terminal devices utilize.

The MME 39 supports end-user authentication as well as initiation and negotiation of ciphering and integrity protection algorithms. The MME 39 also handles terminal-to-network sessions by controlling all the signaling procedures used to set up packet data context and negotiate associated parameters like QoS. The MME 39 further is responsible for idle terminal location management by using a tracking area update process to enable the network to join terminals for incoming sessions.

The major improvement provided in Release 7 of the 3GPP standards, in terms of policy and charging, is the definition of a new converged architecture to allow the optimization of interactions between the Policy and Rules functions. Release 7 of the 3GPP standards involves a new network node, Policy and Charging Rules Function (PCRF) node 41, which is a concatenation of Policy Decision Function (PDF) and Charging Rules Function (CRF).

Release 8 further enhances PCRF functionality by widening the scope of the Policy and Charging Control (PCC) framework to facilitate non-3GPP access to the network (e.g. WiFi or fixed IP broadband access). In the generic policy and charging control 3GPP model, the Policy and Charging Enforcement Function (PCEF) is the generic name for the functional entity that supports service data flow detection, policy enforcement and flow-based charging. The Application Function (AF) represents the network element that supports applications that require dynamic policy and/or charging control. In the IMS model, the AF is implemented by the Proxy Call Session Control Function (P-CSCF).

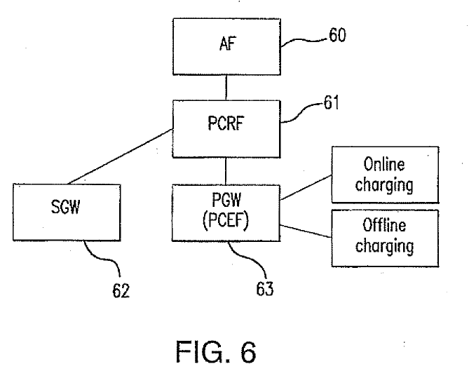

FIG. 6 depicts how the PCRF node interfaces with other EPC elements. The PCRF node 61 connects to the AF element 60, the PGW 63 and the SGW 62.

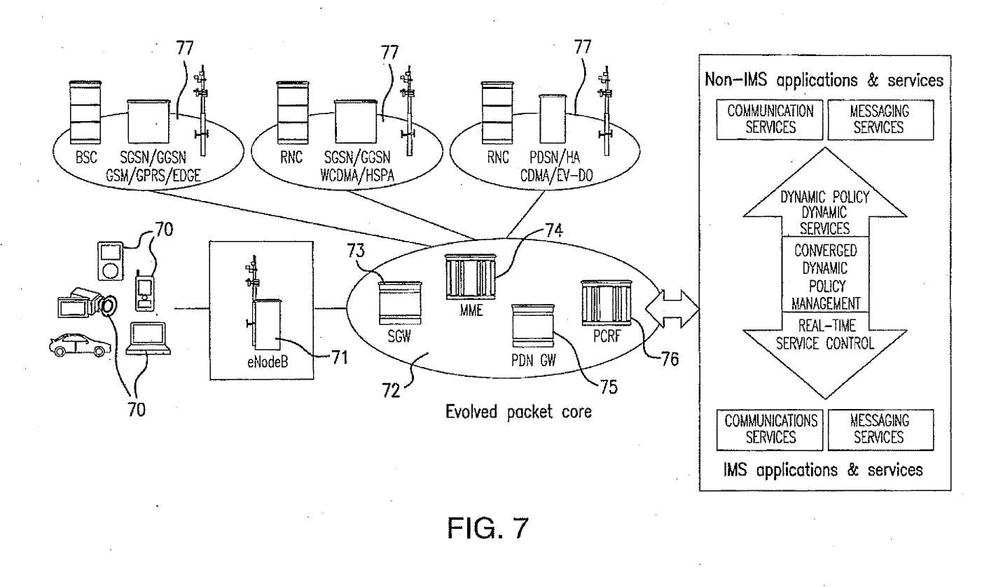

FIG. 7 depicts the dynamic nature of policy and mobility management in a LTE network. The LTE network of FIG. 7 is an end-to-end all-IP network from mobile handsets and other terminal devices 70 with embedded IP capabilities over IP-based Evolved NodeBs 71 and across the EPC 72. The EPC 72 has a SGW 73, a MME 74, a PDN GW 75 and a PCRF 76. The EPC 72 is capable of connecting to a variety of mobile networks 77 and performing dynamic management of mobility, data sessions and network policies.

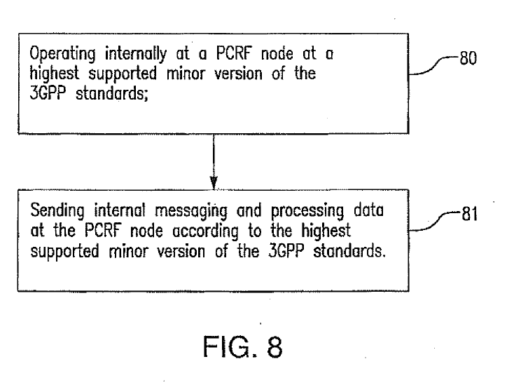

FIG. 8 depicts a method of internal operation at the PCRF node according to a first embodiment. The methodology involves operating internally at a PCRF node at a highest supported minor version of the 3GPP standards 80. The highest supported minor version of the 3GPP standards is usually considered the most recent/up-to-date minor version of the 3GPP standards that a given PCRF node supports. Operating internally at a PCRF node at the highest supported minor version of the 3GPP standards may include an operation for sending internal messaging and processing data at the PCRF node according to the highest supported minor version of the 3GPP standards 81.

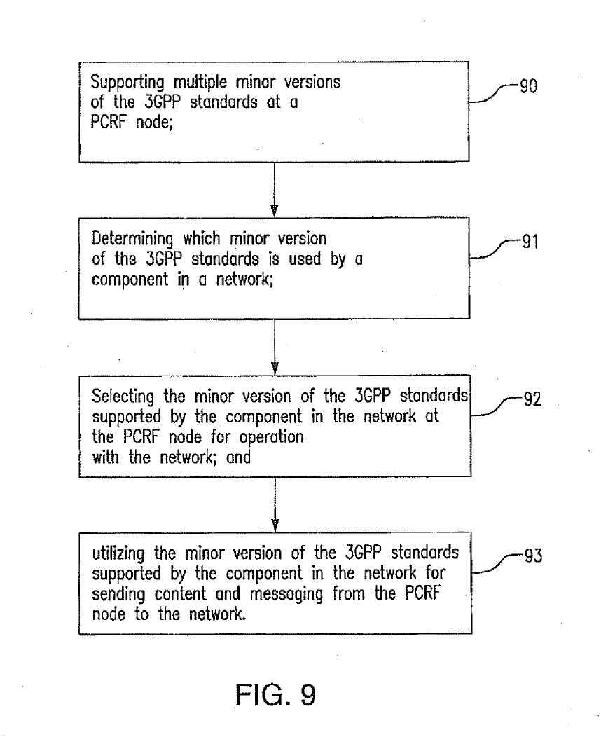

FIG. 9 depicts a method of operation of the interface components of a PCRF node according to a second embodiment. An operation for supporting multiple minor versions of the 3GPP standards at the PCRF node 90 is performed. An operation for determining which minor version of the 3GPP standards is used by a component in a network at the PCRF node 91 is performed.

An operation for selecting the minor version of the 3GPP standards supported by the component in the network at the PCRF node for operation with the network 92 is also performed. An operation for utilizing the minor version of the 3GPP standards supported by the component in the network for sending content and messaging from the PCRF node to the network 93 is performed.

Alternatively, an operation for selecting a minor version of the 3GPP standards to be supported by at least one interface component of a PCRF node by a network operator is performed. An operation for operating the at least one interface component at the PCRF node at the minor version of the 3GPP standards selected by the network operator is performed.

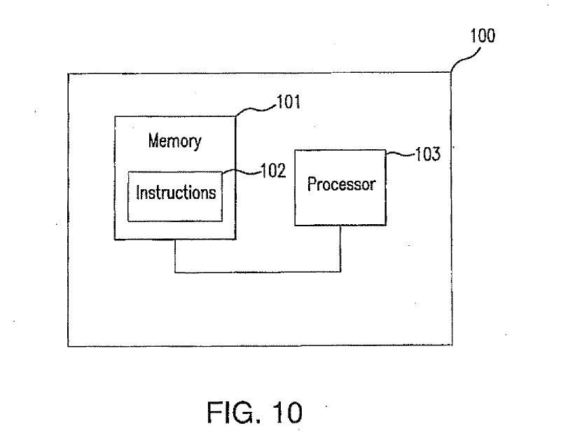

FIG. 10 depicts a device in accordance with a third embodiment that is capable of operating according to different minor versions of the 3GPP standards. The device (e.g. PCRF node) 100 includes a memory 101 containing instructions 102 processed by a processor 103. The instructions may include instructions for operating internally at the PCRF node at a highest supported minor version of the 3GPP standards; sending internal messaging and processing data at the PCRF node according to the highest supported minor version of the 3GPP standards; supporting multiple minor versions of the 3GPP standards at the PCRF node; determining which minor version of the 3GPP standards is used by a component in a network; selecting the minor version of the 3GPP standards supported by the component in the network for operation with the network; and utilizing the minor version of the 3GPP standards supported by the component in the network for sending content and messaging from the PCRF node to the network.

Alternatively, the device may contain instructions for selecting a minor version of the 3GPP standards to be supported by at least one interface component of a PCRF node by a network operator and for operating the at least one interface component at the PCRF node at the minor version of the 3GPP standards selected by the network operator.

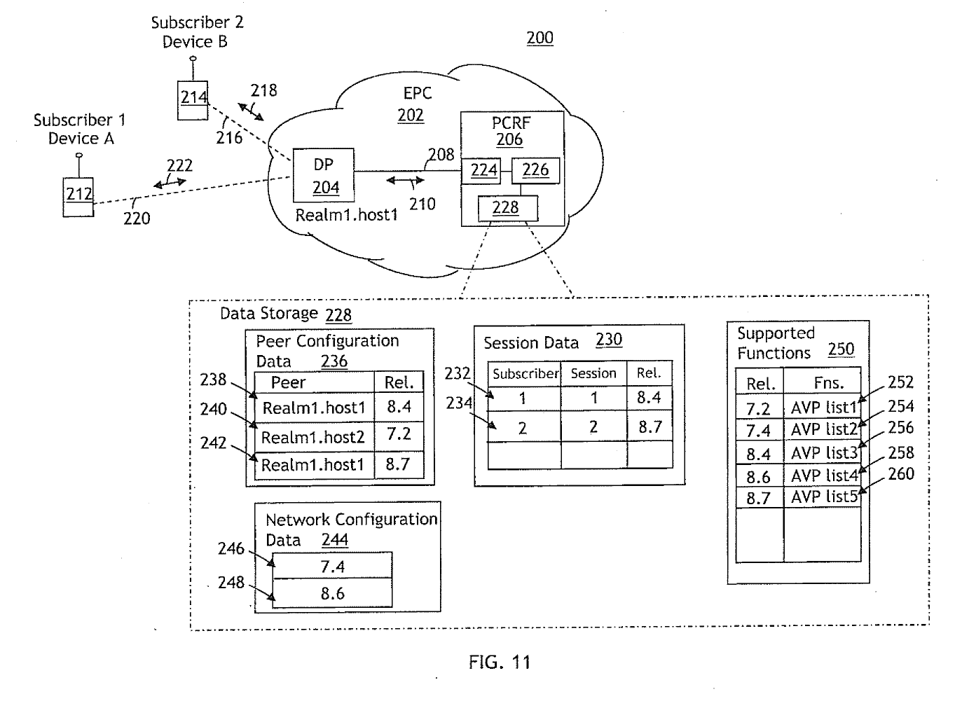

FIG. 11 depicts an alternative implementation of the device of FIG. 10 in accordance with a fourth embodiment and in context of an LTE network 200 having an EPC 202. The device is implemented in a PCRF node 206 that communicates Diameter protocol messages 210 with a Diameter Peer (DP) 204 over a link 208. The Diameter Peer 204 is identified by a realm and hostname, for example “Realm1.host1” as shown in the figure, in accordance with the Diameter Protocol. The DP 204 would typically be a SGW 38 or PDN GW 40 as shown in FIG. 3. A first wireless device 212 labeled Device A and associated with a first subscriber, Subscriber 1, communicates 222 with the DP 204 over a link 220, which comprises both wireless and wireline technologies, for example as shown in FIG. 1. Likewise a second wireless device 214 labeled Device B and associated with a second subscriber. Subscriber 2, communicates 218 with the DP 204 over a link 216, which also comprises both wireless and wireline technologies.

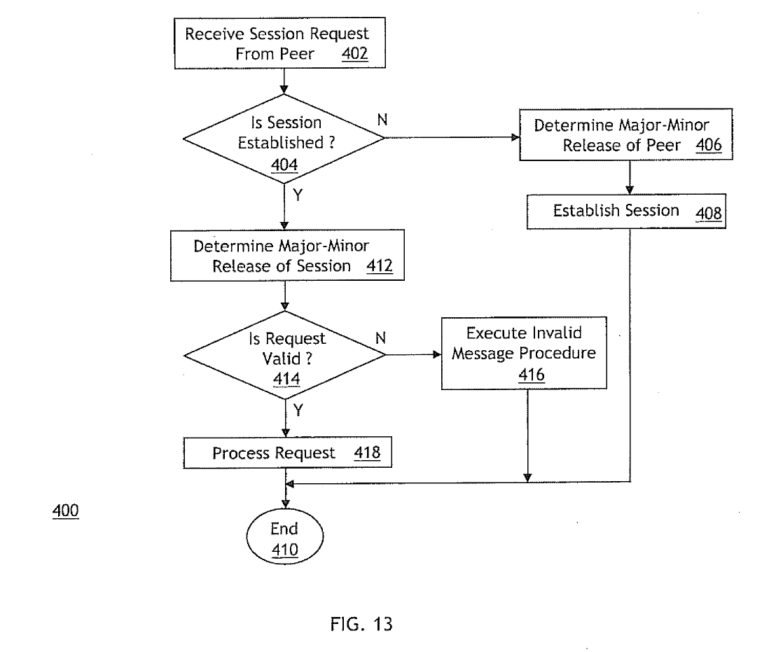

The PCRF node 206 includes a Gx interface 224 coupled to the link 208 for communicating the Diameter Protocol messages 210 with the DP 204. The interface is coupled to a controller 226, which comprises the memory 101 and the processor 103 shown in FIG. 10. The controller 226 is coupled to data storage 228 adapted to store, and that in operation stores, peer configuration data 236, session data 230, network configuration data 244, and an indication of supported functions 250. The controller 226 is operable to perform steps in accordance with an embodiment that will be described late with reference to FIG. 13. The controller 226 is adapted to be operable as such by programming the memory 101 with the instructions 102.

The peer configuration data 236 includes entries 238, 240, 242 for Diameter Peers and the major-minor release combination under which each was operating at the time the entry was made. For example, a first entry 238 associates the DP 204 by its realm and hostname, Realm1.host1, with a first major-minor release combination shown in the format “major release.minor release”, which in this case is “8.4”. A second entry 240 associates another Diameter Peer (not shown) having a realm and hostname of “Realm1.host2” with a major-minor release combination of “7.2”. A third entry 242, which is a later entry then the first entry 238, associates the DP 204 by its realm and hostname of “Realm1.host1” with a major-minor release combination of “8.7”.

The network configuration data 244 includes default network-wide entries 246, 248 of major-minor release combinations for Diameter Peers. For example, a first default entry 246 indicates a network-wide major-minor release combination of “7.4”, which is in the same “major.minor” format of the peer configuration data previously described. A second default entry 248, which was entered later than the first default entry 246, indicates a network-wide major-minor release combination of “8.6”. The default network-wide major-minor release combination is used when a Diameter Peer does not have an entry in the peer configuration data 236 for a given major release. As will be described later, the major release may be indicated in a Diameter protocol message 210 received by the PCRF node 206.

The session data 230 includes session entries 232. 234 that each associate a subscriber identifier and a session identifier with a major-minor release combination identifier. For example, a first session entry 232 associates the first subscriber, Subscriber 1 identified by a “1” in the entry 232, and a corresponding session, identified by a “1” in the entry 232, with a major-minor release combination “8.4”, which is in the same “major.minor” format previously described. A second session entry 234 associates the second subscriber, Subscriber 2 identified by a “2” in the entry 234, and a corresponding session, identified by a “2” in the entry 234, with a major-minor release combination “8.7”. As will be described later, the session data 230 is used may be used when the PCRF node 206 receives in a Diameter protocol message 210 regarding an existing session.

The indication of supported functions 250 includes entries 252, 254, 256, 258, and 260, each that associate a given major-minor release combination with functions supported according to that major-minor release combination. The functions are specified as a list of attribute value pairs (AVPs). The particular AVPs included in a given list are in accordance with those specified by the 3GPP standards for the corresponding major-minor release combination. As will be described later, the indication of supported functions 250 may be used to validate a Diameter protocol message 210 received by the PCRF node 206 in dependence upon a major-minor release combination determined for a Diameter peer that sent the message or an established session to which the message 210 relates.

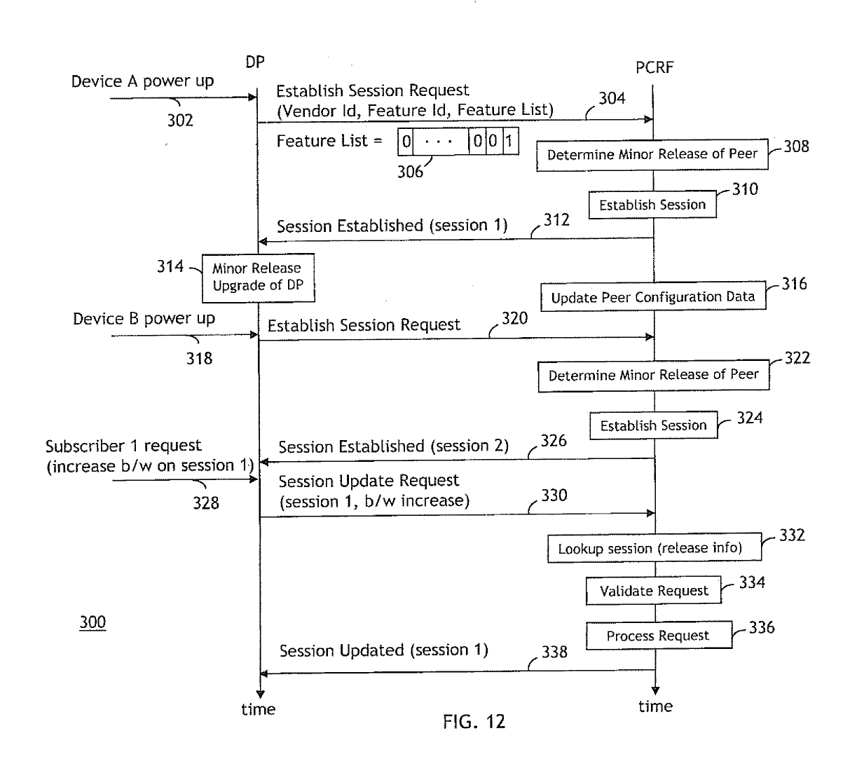

FIG. 12 depicts operation of the PCRF node 206 and messaging between the PCRF node 206 and an EPC node in a release upgrade scenario 300 and in accordance with a fifth embodiment. In this case the EPC node is represented by the DP 204, as previously described. The origination and termination of messages at the DP 204 and PCRF node 206, and the respective operations, are depicted along two vertical lines labeled DP and PCRF with time advancing from top to bottom of the figure. Reference to FIG. 11 is made in the following description.

The scenario starts when the DP 204 receives an indication 302 that device A has powered up. The DP 204 then sends a request message 304 to the PCRF 206 to establish a session for the Device A. The message is in accordance with Diameter protocol messaging and as defined by the 3GPP standards, particularly the Gx interface. The request 304 includes a vendor identifier, a feature identifier and a feature list. The feature list, as defined by the 3GPP standards, includes an indication of a major release of the 3GPP standard under which the session is to be established, the indication taking the form of a binary word having certain bits set in a predefined manner to indicate the major release. In this case bit 0 of the word is set, which indicates major release 8 is to be used for the session. There is no indication of the minor release in the request 304.

Upon receiving the request 304 the PCRF 206 initiates a step to determine 308 the minor release of the DP 204. For example, based on the realm and host name of DP 204, i.e. Realm1.host1, and the specified major release being release 8, the PCRF 206 determines from the first entry 238 in the peer configuration data 236 that the DP 204 is operating at a major-minor release combination of 8.4. That is the PCRF 206 determines the DP 204 is operating at a minor release of “0.4”. Subsequent to successfully making the determination 308, the PCRF 206 initiates a step to establish 310 the requested session. Upon successful establishment of the session, the PCRF 206 sends a response message 312 to the DP 204 confirming that the session has been established and providing an identifier for the session, e.g. session 1. The session identifier, subscriber identifier, and major-minor release combination are written into the first entry 232 of the session data 230.

At some future time a minor release upgrade 314 is performed on the DP 204, for example from minor release “0.4” to minor release “0.7”. The functionality of the DP 204 as defined by major release 8 is not affected by the minor release upgrade in accordance with the 3GPP standards. However, the minor release upgrade does alter the functionality of the DP 204; the specifics of the functionality would be defined by the 3GPP standards for major-minor release combinations 8.4 and 8.7. Subsequent to the minor release upgrade 314 of the DP 204, the peer configuration data 236 of the PCRF node 206 is updated to indicate the latest major-minor release combination at which the DP 204 is operating, which in this case in 8.7 as recorded at the third entry 242 under Realm1.host1. Updating of the peer configuration data 236 could be done manually, e.g. via a GUI interface at the PCRF node 206.

Some time after the minor release upgrade 314, the DP 204 receives a message 318 indicating that another user device, Device B has powered up. In a similar series of operations and messaging as described before with respect to the power up of device A, the DP 204 and PCRF 206 establish a session for Device B. However, this time the session is established under a new major-minor release combination at which the DP 204 is operating, namely 8.7 as previously described. Specifically, the DP 204 sends a request message 320 to the PCRF node 206 to establish a session for Device B. Upon receipt of the request 320 the PCRF initiates a step to determine 322 the minor release at which the DP 204 is operating. To do so, the PCRF 206 looks up in the peer configuration data 236 the latest major-minor release combination recorded for the DP 204, which in this case is stored in the third entry 242 under Realm1.host1 as major-minor release combination “8.7”. The PCRF 206 establishes 324 the requested session and records in the session data 230 at the second entry 234 an indication of the subscriber, e.g. subscriber 2, the session, e.g. session 2, and the major-minor release combination 8.7. A response message 326 confirming establishment of the session is sent to the DP 204. The response message 326 may include an identifier of the session. e.g. session 2.

Some time after the session 2 is established, the DP 204 receives another request message 328 corresponding to the Device A in which the first subscriber, subscriber 1, requests an increase in allowed bandwidth on the session 1. This request is but one of many different types of requests that could be made relating to an existing session. Subsequent to receiving the request 328, the DP 204 sends a request message 330 to the PCRF 206 to request an increase to the allowed bandwidth of the session 1. Upon receiving the request 330, the PCRF node 206 initiates a step to lookup the release information corresponding to the session 1. The PCRF node 206 obtains the release information for the session 1 by retrieving the major-minor release combination stored in the first entry 232 of the session data 230, which combination in this case is 8.4. Note that since the session 1 is an existing session the PCRF node 206 did not consult the peer configuration data 236 for the release combination. This functionality enables the PCRF node 206 to deal with existing sessions according to the release combination under which they were established and to deal with the creation of new sessions under the latest major-minor release combination of the Diameter peer in question, which release combination could be different. This aspect is important for the next step performed by the PCRF node in regard to the request 330, which is to validate 334 the request 330 in accordance with the release combination under which the session was created. This validation is done by in part by checking the request 330 against a list of supported AVPs for the relevant release combination, which list is stored in the information of supported functions 250. In this case a third entry 256 in the supported functions 250 corresponds to the relevant major-minor release combination of 8.4. Upon successful validation 334 of the request 330 the PCRF node 206 processing 336 the request 330 and provides the DP 204 with a response message 338 confirming that the requested update to the session 1 has been made.

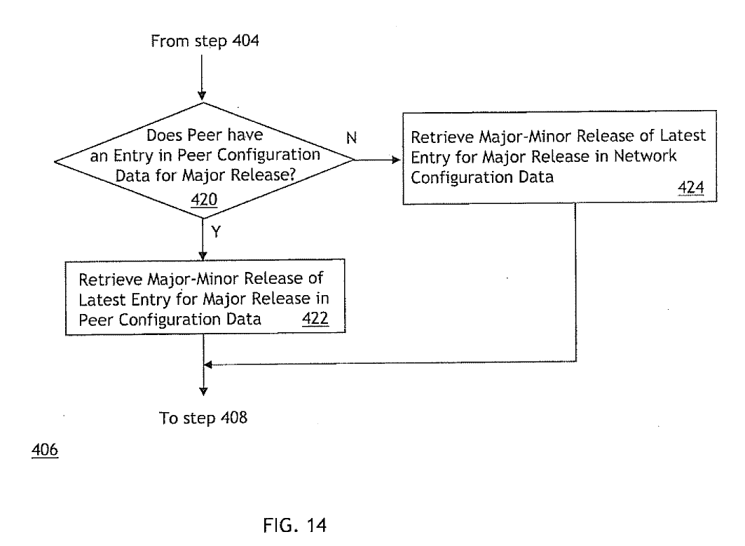

FIG. 13 depicts a method 400 of managing sessions performed at the PCRF node 206 in accordance with a sixth embodiment. The method starts when a request message, also referred to simply as a request, is received 402 from a Diameter peer node, e.g. the DP 204. For example the request could any of the request messages 304, 320, and 330 shown in FIG. 12. The PCRF node 206 then determines 404 if an established session is related to the request, e.g. by consulting the session data 230. Responsive to determining 404 that there is no established session related to the request, the PCRF node 206 determines 406 a major-minor release combination of the Diameter peer. The details of making this determination 406 will be described later with reference to FIG. 14. The PCRF node 206 then establishes 408 a new session in accordance with the request and execution of the method 400 ends 410. Establishing 408 the new session may include updating the session data 230 and sending a response message, e.g. response messages 312 and 320, to the Diameter peer.

If the PCRF node 206 determines 404 that there is an established session related to the request, then the PCRF node 206 determines 412 the major-minor release combination corresponding to that session, e.g. by consulting the session data 230. The PCRF node 206 then determines 414 if the request is valid, which determination 414 may include comparing content of the request to the information of supported functions 250 for the major-minor release combination corresponding to that session. For example, the request might include an AVP that does not appear in the supported functions for the corresponding major-minor release combination, in which case the PCRF node 206 would determine 414 that the request is not valid. Responsive to determining 414 that the request is invalid, the PCRF node 206 initiates an invalid message procedure 416, which among other things could result in the PCRF node 206 sending a response message to the Diameter peer indicating that the request was rejected or failed. After executing, or at least initiating, the invalid message procedure 416 the method 400 ends 410.

If the PCRF node 206 determines 414 that the request is valid, then the PCRF node 206 processes 418 the request and the method 400 ends 410. Processing 418 the request may include updating the session data 230 and sending a response message, e.g. response messages 338, to the Diameter peer.

FIG. 14 depicts in greater detail the step of determining 406 the major-minor release combination of the Diameter peer. This step 406 is performed by determining 420 if the Diameter peer has an entry in the peer configuration data 236 for the major release specified in the request, e.g. as by the feature List 306 included in the request. To make this determination 420 the PCRF node 206 looks for any entry in the peer configuration data 236 that corresponds to the realm and host name of the Diameter peer and to the major release specified in the request. For example, the DP 204 has two entries 238 and 242 in the peer configuration data 236 that correspond to its realm and host name, i.e. “Realm1.host1” and to the major release version 8. Responsive to determining 420 that the Diameter peer does have an entry in the peer configuration data 236 corresponding to the major release, the PCRF node 206 retrieves 422 the latest such entry if there is more than one, which in the case of the aforementioned example would be the second entry 242 corresponding to the major-minor release combination “8.7”. However, if the PCRF node 206 determines 420 that there is not an entry corresponding to the Diameter peer and the major release specified in the request, then the PCRF node 206 retrieves 424 from the network configuration data 244 the latest entry of the major-minor release combination for the major release specified in the request. With respect to the aforementioned example regarding major release 8, the PCRF node 206 would retrieve 424 the second entry 248 from the network configuration data 244, which entry indicates a major-minor release combination of “8.6”.

It is contemplated that the methods described herein can be implemented as software, including a computer-readable medium having program instructions executing on a computer, hardware, firmware, or a combination thereof. The methods described herein also may be implemented in various combinations on hardware and/or software.

A person of skill in the art would readily recognize that steps of the various above-described methods can be performed by programmed computers and the order of the steps is not necessarily critical. Herein, some embodiments are intended to cover program storage devices, e.g., digital data storage media, which are machine or computer readable and encode machine-executable or computer executable programs of instructions where said instructions perform some or all of the steps of methods described herein. The program storage devices may be, e.g., digital memories, magnetic storage media such as magnetic disks or tapes, hard drives, or optically readable digital data storage media. The embodiments are also intended to cover computers programmed to perform said steps of methods described herein.

It will he recognized by those skilled in the art that changes or modifications may be made to the above-described embodiments without departing from the broad inventive concepts of the invention. It should therefore be understood that this invention is not limited to the particular embodiments described herein, but is of the invention as set forth in the claims.

What is claimed is:

1. A device for controlling sessions in a network comprising:
an interlace for communicating with an entity operable to send and receive messages regarding a session;
data storage adapted to store session data related to the session and to store configuration data corresponding to the entity; and
a controller operable to determine, from the configuration data, a major-minor release combination of the entity responsive to receiving, from the entity, a message requesting establishment of a new session, and to determine, from the session data, a major-minor release combination of an existing session responsive to receiving, from the entity, a message regarding the existing session.

2. The device of claim 1 wherein the data storage is further adapted to store network configuration data, and the controller is further operable to determine, in the absence of configuration data corresponding to the entity, a major-minor release combination from the configuration data responsive to receiving the message requesting establishment of the new session.

3. The device of claim 2 wherein the data storage is further adapted to store information corresponding to functions supported by the device for a given major-minor release combination, and the controller is operable to validate, in dependence upon said information, the message regarding the existing session.

4. The device of claim 1 wherein the device is implemented as a policy and charging rules function (PCRF) node.

5. The device of claim 1 wherein the device is implemented as a circuit card for installation in a network node.

6. The device of claim 1 wherein the entity is a Diameter peer node.

7. The device of claim 7 wherein the interface is a Gx interface for exchanging Diameter messages.

8. The device of claim 3 wherein the information corresponding to functions is a list of attribute value pairs (AVPs).

9. A method of controlling sessions performed by a device comprising the steps of:
receiving a session request from a node;
determining if there is an established session corresponding to the request;
determining, responsive to there not being an established session, a major-minor release combination at which the node is operating and establishing a new session associated with the major-minor release combination; and
determining, responsive to there being an established session, a major-minor release combination associated with the established session.

10. The method of claim 9 further comprising:
if there is said established session:
determining if the request is valid;
executing an invalid message procedure responsive to the request not being valid; and
processing the request responsive to the request being valid.

11. The method of claim 9 wherein determining the major-minor release combination at which the node is operating comprises:
determining if there is an entry for the node in a storage of configuration data:
retrieving, responsive to there not being said entry, a default network-wide major-minor release combination identifier from said storage; and
retrieving, responsive to there being said entry, an identifier indicating the major-minor release combination at which the node is operating from said storage.

12. The method of claim 10 wherein determining if the request is valid comprises comparing an attribute value pair of the request with an indication of attribute value pairs supported by the major-minor release combination associated with the established session.

13. The method of claim 9 wherein the steps of the method are performed by a PCRF node.

14. The method of claim 9 wherein the request is formed as a Diameter protocol message.

15. The method of claim 11 wherein the steps of the method are performed by a PCRF node and the storage of configuration data resides in the PCRF node.

16. The method of claim 12 wherein the steps of the method are performed by a PCRF node and the indication of attribute value pairs resides in the PCRF node.
